(19) United States
(12) Patent Application Publication
(10) Pub. No.: US 2025/0293503 A1
(43) Pub. Date: Sep. 18, 2025

(54) TRANSITIONAL GAUGE CHANGE CABLE ADAPTERS

(71) Applicant: Molex, LLC, Lisle, IL (US)

(72) Inventors: Augusto P. Panella, Naperville, IL (US); Steven D. Miller, Maumelle, AR (US)

(21) Appl. No.: 19/058,055

(22) Filed: Feb. 20, 2025

Related U.S. Application Data
(60) Provisional application No. 63/565,006, filed on Mar. 14, 2024.

(51) Int. Cl. H02G 15/117; H02G 15/113

(52) U.S. Cl. CPC H02G 15/117; H02G 15/113

(57) ABSTRACT

Aspects and embodiments of transitional cable adapters are described. An example cable adapter includes a housing, a shield, and an adapter ferrule. The adapter ferrule includes a conductive aperture. The conductive aperture includes a first aperture length, a second aperture length, and a transition between the first and second lengths. The conductive aperture includes a conductive lining on an inner surface in one example. The first aperture length can be formed to a first diameter for a first gauge of a first conductor, and the second aperture length can be formed to a second diameter for a second gauge of a second conductor. An improved transition provided by the cable adapter can reduce signal reflections, reduce interference and crosstalk, reduce distortion, increase signal to noise ratios, and increase bandwidth in transitions between conductors of different diameters, such as conductors of different diameters in twinax cables.

### BACKGROUND

The amount of data processed by computing, network switching, telecommunications, and related systems continues to increase. Data centers can include hundreds or thousands of networking and computing systems. The systems are interconnected by optical cables, copper cables, and various connectors, adapters, and terminations between them. The data throughput of the interconnection systems is high and increasing. A range of different input/output (I/O) connectors, cables, cable assemblies, and interconnect systems are designed for those types of data, power, and data and power interconnection applications.

Example interconnect systems include board-to-board, wire-to-wire, and wire-to-board systems. A variety of designs exist for each type of connector, cable assembly, and interconnect system, depending on the requirements of the power and data communications environment in which the connectors, assemblies, and systems are used. As one example, a wire-to-board system includes a free-end connector attached to a cable bundle of wires and a fixed-end connector attached to a printed circuit board (PCB). As another example, a wire-to-wire system includes a first free-end connector attached to one end of cable bundle and a second free free-end connector attached to another end of the cable bundle.

### SUMMARY

Aspects and embodiments of transitional cable adapters are described. Improved transitions provided by the cable adapters can reduce signal reflections, reduce interference and crosstalk, reduce distortion, increase signal to noise ratios, and increase bandwidth in transitions between conductors of different diameters, such as conductors of different diameters in twinax cables, for example.

An example transitional cable adapter includes a housing, a shield, and an adapter ferrule. The adapter ferrule includes a conductive aperture. The conductive aperture includes a first aperture length for a first conductor, a second aperture length for a second conductor, and a transition between the first aperture length and the second aperture length. The housing is molded around the shield and the adapter ferrule in some examples.

In other aspects, the adapter ferrule includes a dielectric insulating material, and the conductive aperture of the adapter ferrule includes a lining of conductive material on an inner surface in one example. The first aperture length includes a first diameter for a first gauge of the first conductor, and the second aperture length includes a second diameter for a second gauge of the second conductor.

In other aspects, the shield includes a lower shield plate and an upper shield plate, and the adapter ferrule is positioned in a transition channel between the lower shield plate and the upper shield plate. In some cases, the lower shield plate is welded to the upper shield plate in at least one location. In other examples, the shield includes a transition channel. The transition channel includes an adapter seat for the adapter ferrule, a shield seat for a shield of a cable, a jacket seat for an outer jacket of the cable, and drain pockets for drain conductors of the cable. The shield seat includes a roughened surface area in some cases.

In other examples, the adapter ferrule includes an upper ferrule section and a lower ferrule section. At least one of the upper ferrule section or the lower ferrule section includes a first channel length for the first conductor, a second channel length for the second conductor, and a transition between the first channel length and the second channel length.

Another transitional cable adapter includes a first cable with a first conductor of a first gauge, a second cable with a second conductor of a second gauge different than the first gauge, an adapter ferrule, and a shield around the adapter ferrule. The adapter ferrule includes an aperture. The aperture includes a first diameter for the first conductor, a second diameter for the second conductor, and a transition between the first diameter and the second diameter.

In other aspects, the adapter ferrule includes a dielectric insulating material, and the aperture of the adapter ferrule includes a lining of conductive material on an inner surface. The shield includes a lower shield plate and an upper shield plate, and the adapter ferrule is positioned in a transition channel between the lower shield plate and the upper shield plate. In some cases, the lower shield plate is welded to the upper shield plate in at least one location.

In other aspects, the shield includes a transition channel, the transition channel includes an adapter seat for the adapter ferrule, a first drain pocket for a first drain conductor of the first cable, and a second drain pocket for a second drain conductor of the second cable. The first drain conductor of the first cable includes a first angled length, the second drain conductor of the first cable includes a second angled length, the first angled length is positioned within the first drain pocket, and the second angled length is positioned within the second drain pocket.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a perspective view of an example cable according to various embodiments of the present disclosure.

FIG. 1B illustrates a front view of the example cable shown in FIG. 1A according to various embodiments of the present disclosure.

FIG. 2A illustrates a perspective view of an example transitional cable adapter between cables according to various embodiments of the present disclosure.

FIG. 2B illustrates an exploded perspective view of the cable adapter and cables shown in FIG. 2A according to various embodiments of the present disclosure.

FIG. 2C illustrates a perspective view of the cable adapter and cables shown in FIG. 2A, with certain components omitted, according to various embodiments of the present disclosure.

FIG. 3A illustrates a perspective view of an example lower shield plate in the transitional cable adapter shown in FIG. 2A according to various embodiments of the present disclosure.

FIG. 3B illustrates a plan view of the region designated “3B” in FIG. 2C according to various embodiments of the present disclosure.

FIG. 4A illustrates a front perspective view of an example adapter ferrule in the transitional cable adapter shown in FIG. 2A according to various embodiments of the present disclosure.

FIG. 4B illustrates a back perspective view of the adapter ferrule shown in FIG. 4A according to various embodiments of the present disclosure.

FIG. 4C illustrates a front view of the adapter ferrule shown in FIG. 4A according to various embodiments of the present disclosure.

FIG. 4D illustrates a back view of the adapter ferrule shown in FIG. 4A according to various embodiments of the present disclosure.

FIG. 4E illustrates an exploded view of the adapter ferrule shown in FIG. 4A according to various embodiments of the present disclosure.

FIG. 4F illustrates a plan view of the lower ferrule section shown in FIG. 4E according to various embodiments of the present disclosure.

FIG. 5A illustrates a perspective view of another example transitional cable adapter between cables according to various embodiments of the present disclosure.

FIG. 5B illustrates an exploded perspective view of the cable adapter and cables shown in FIG. 5A according to various embodiments of the present disclosure.

FIG. 5C illustrates a perspective view of an upper shield body of the transitional cable adapter shown in FIG. 5A according to various embodiments of the present disclosure.

FIG. 5D illustrates a perspective view of a lower shield body of the transitional cable adapter shown in FIG. 5A according to various embodiments of the present disclosure.

### DETAILED DESCRIPTION

As noted above, the amount of data processed by computers, computing systems, and computing environments continues to increase. Data centers can include hundreds or thousands of networking and computing systems that are interconnected using optical cables, copper cables, and various connectors and terminations therebetween. Data is often carried on these cables using radio frequency (RF) signals at microwave frequencies. A range of different interconnection techniques can be relied upon in data centers, such as die-to-die, die-to-optical engine, chip-to-module, chip-to-chip on the same printed circuit board (PCB), chip-to-chip on different PCBs, and other interconnections. To achieve higher throughputs, some interface technologies use direct attach copper cable (DAC), active optical cable (AOC), and other interconnect solutions.

Increasing data throughput is a primary concern in the design of cables, connectors, and interconnects for microwave signals in data centers and related computing environments. In that context, the transitions between different conductors in different cables should be carefully considered and designed. A number of different electrical and mechanical arrangements have been proposed to maintain signal bandwidth and integrity at transitions between conductors for microwave signals. Even well-designed transitions can impart electrical discontinuities, impedance or permittivity mismatches, and other mismatches at interfaces between conductor-to-conductor transitions, among other issues. The extent of the mismatches depends on several factors, including the mechanical and electrical variations at the transitions between the conductors of the cables. Any impedance or permittivity mismatches at the transitions can result in signal reflections, near-end and far-end interference and crosstalk, distortion, signal noise, decreased bandwidth, and other issues. Additionally, differences between the signal path and the ground return path can lead to electromagnetic wave skew, distortions, and result in additional sources for spurious mode propagation. The concepts and embodiments described herein are designed to reduce the unwanted transitional effects described above, among other unwanted effects.

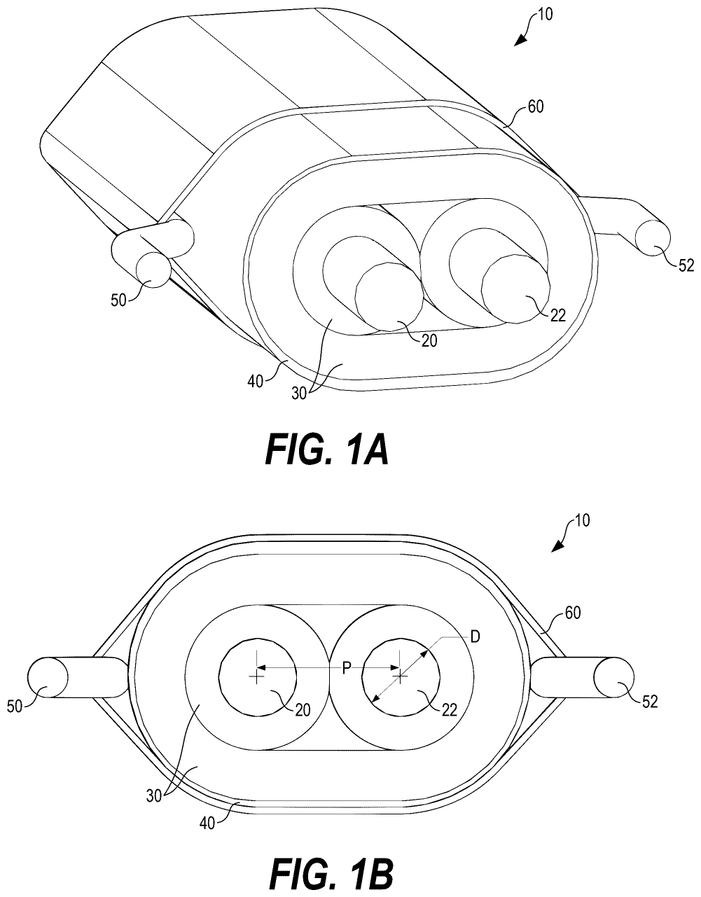

Turning to the drawings, FIG. 1A illustrates a perspective view of an example cable 10 according to various embodiments of the present disclosure, and FIG. 1B illustrates a front view of the cable 10 shown in FIG. 1A. The cable 10 is provided as an example of an electrical interconnect capable of transmitting data signals. The cable 10 is illustrated as a representative example and is not drawn to any particular scale or size. The shape, size, proportion, and other characteristics of the cable 10 can vary as compared to that shown. For example, the gauge (e.g., American Wire Gauge (AWG)) of the conductors in the cable 10 can vary, among other characteristics of the cable 10. Additionally, one or more of the parts of the cable 10, such as the shielding layers, the drain conductors, or other parts can be omitted in some cases, and the cable 10 can also include other parts or components that are not illustrated in FIGS. 1A and 1B.

Referring between FIGS. 1A and 1B, the cable 10 includes a first inner conductor 20, a second inner conductor 22, a dielectric insulator 30, a shield 40, a first drain conductor 50, a second drain conductor 52, and a jacket 60. The cable 10 is similar to coaxial cables in some aspects but includes two inner conductors 20 and 22, rather than a single inner conductor. With two inner conductors, the cable 10 is an example of a twinaxial or twinax cable. Twinax cables such as the cable 10 can be particularly suited for use in short-range, high-speed differential data signaling applications, for example, although the cable 10 can be relied upon in a range of data interconnection applications.

The conductors 20 and 22 can be embodied as copper conductors, copper-clad steel conductors, or conductors formed from other metals. In some cases, the conductors 20 and 22 can include an outer-surface plating of silver or other metals. As examples, the conductors 20 and 22 can range in gauge, such as between 22-34 AWG, although the cable 10 can include conductors of other gauges. Data signals can be differentially coupled to the conductors 20 and 22, as one example, and the cable 10 can be used to communicate data using a range of modulation and signaling techniques. Additional aspects of the conductors 20 and 22 are described below.

The dielectric insulator 30 can be embodied as a core of dielectric insulating material. As examples, the dielectric insulator 30 can be embodied as a solid or low-density polyolefin, polyethylene (PE), polytetrafluoroethylene (PTFE), fluoropolymer, or other plastic or insulating material. Example dielectric constants (Dk) of the dielectric insulator 30 can range from 1.5-3, although the cable 10 is not limited to any particular type or characteristic of insulating material. The conductors 20 and 22 are positioned within the dielectric insulator 30 as shown. The distance or spacing between the outer surface of the conductors 20 and 22 and the outer surface of the dielectric insulator 30 (i.e., at the interface between the dielectric insulator 30 and the first shield 40) can vary in the cable 10.

The shield 40 can be embodied as a relatively thin layer of conductive material, such as aluminum, copper, or other conductive shield layer. The shield 40 is positioned over and covers the outer surface of the dielectric insulator 30 in the example shown. The first and second drain conductors 50 and 52 can be embodied as aluminum, copper, or other metal conductors. As examples, the drain conductors 50 and 52 can range in gauge, but the drain conductors 50 and 52 are generally a larger gauge (i.e., smaller diameter) than the conductors 20 and 22. The drain conductors 50 and 52 contact and are electrically coupled with the shield 40. The jacket 60 can be embodied as any suitable material capable of protecting and permitting sufficient flexibility for the cable 10, such as polyvinyl chloride (PVC), polyurethane, chlorinated PE, or other thermoplastic, thermoset, or related material.

The diameter “D” of the conductors 20 and 22 can vary depending on the gauge of the conductors 20 and 22 used in the cable 10, by definition and as understood in the field. The relative positions (e.g., the pitch “P”) of the conductors 20 and 22, the overall size (e.g., thickness, width, etc.) of the cable 10, and other aspects of the cable 10 can also vary along with the gauge of the conductors 20 and 22. Thus, another cable similar to the cable 10, but including conductors of a different gauge as compared to the conductors 20 and 22, can have conductors that do not spatially align with conductors 20 and 22. The conductors of a different cable may have different diameters “D,” a different pitch “P” between the conductors, a dielectric insulator of a different size, shape, style, or type, different positions and sizes of drain conductors, and other differences as compared to the cable 10. These differences in dimensions and other aspects can present challenges when designing an interface between the cable 10 and another cable of similar style (e.g., another twinax cable) but having conductors of a different gauge, for example, particularly at the transition between them. Similarly, a connector designed for electrical coupling at an end of the cable 10 may not be sized or dimensioned appropriately for a cable of similar style but having conductors of a different gauge.

Many chip-to-chip interconnect solutions rely upon the termination of many twinax cables having conductors of relatively small diameter (e.g., 32 or 34 American Wire Gauge (AWG)) in close proximity to integrated circuit chips or chip modules. Having conductors of smaller diameter, the cables are relatively smaller and can be bundled together more closely with higher density around the chips or chip modules. However, conductors of relatively small diameter are not as suitable for the transmission of data signals at high data rates over longer distances. Thus, it is preferable in many cases to provide a transition from cables having smaller diameter conductors to cables having larger diameter conductors. The cables having larger diameter conductors can then be relied upon to transmit data signals at high data rates over longer distances.

At the same time, the transitions between different conductors in different cables should be carefully considered and designed. Unwanted or undesirable effects can be imparted upon data signals at transitions between conductors in different cables depending on the design of the transition. Examples of the undesirable effects can include signal reflections, near-end and far-end interference and crosstalk, distortion, signal noise, decreased bandwidth, and other issues. The mechanical robustness of the transitions is also a concern.

In the context outlined above, various aspects and embodiments of a transitional gauge change cable adapters are described. An example cable adapter includes a housing, a shield within the housing, and an adapter ferrule. The adapter ferrule includes conductive apertures. The conductive apertures include a first aperture length, a second aperture length, and a transition between the first and second lengths. The conductive apertures include a conductive lining on inner surfaces in one example. The first aperture length can be formed to a first diameter for a first gauge of a first conductor, and the second aperture length can be formed to a second diameter for a second gauge of a second conductor. An improved transition provided by the cable adapter can reduce signal reflections, reduce interference and crosstalk, reduce distortion, increase signal to noise ratios, and increase bandwidth in transitions between conductors of different diameters, such as conductors of different diameters in twinax cables.

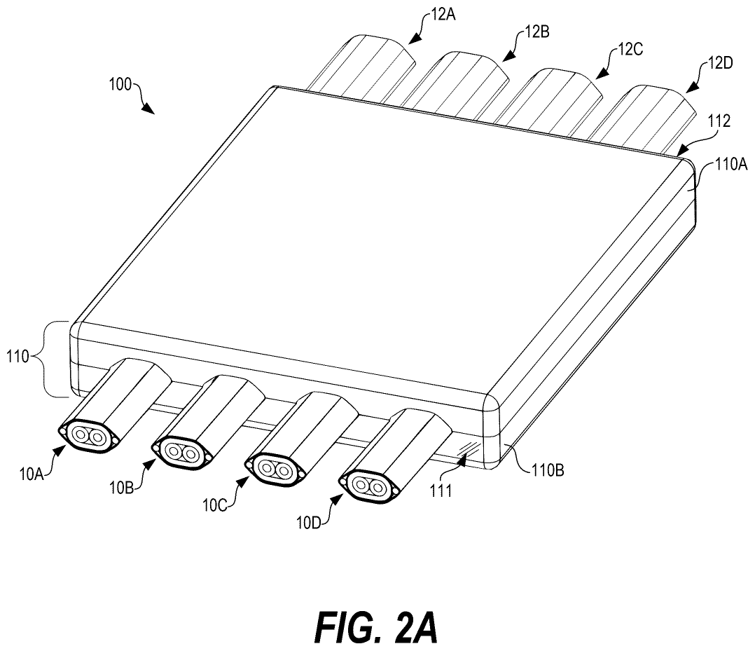

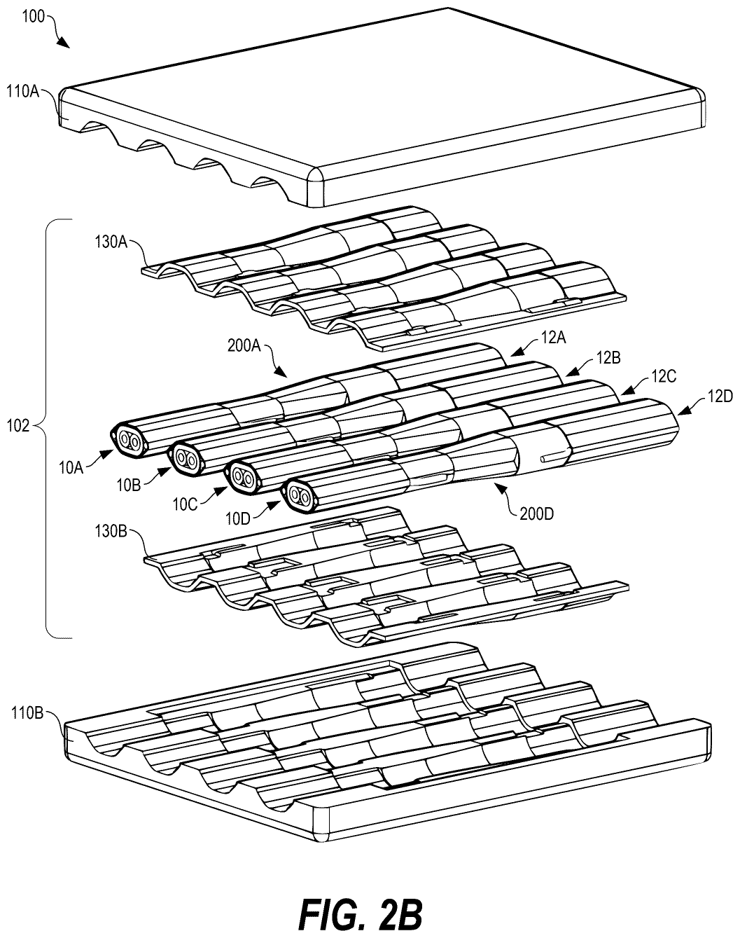

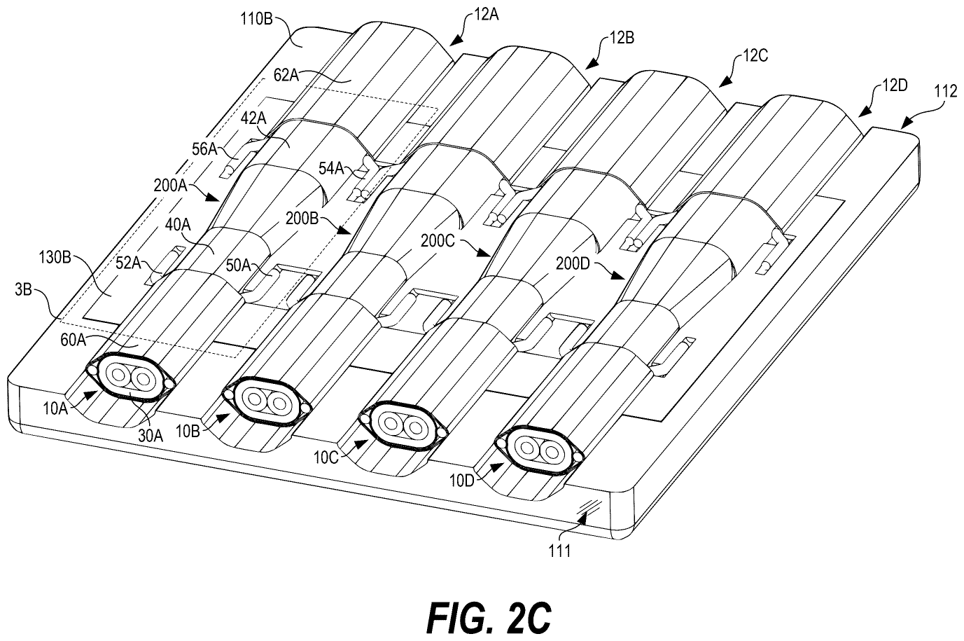

FIG. 2A illustrates a perspective view of an example transitional cable adapter 100 (also “cable adapter 100”) between cables according to various embodiments of the present disclosure. The cable adapter 100 is illustrated as a representative example and is not drawn to any particular scale or size. The shape, size, style, proportion, and other characteristics of the cable adapter 100 can vary as compared to that shown and among the embodiments. In some cases, one or more features or components of the cable adapter 100 and the other cable adapters described herein can be omitted. In other cases, the cable adapter 100 and other cable adapters described can include other features or components. Additionally, while the cable adapter 100 and other connectors discussed herein are described for use in high speed interconnect applications, the concepts are not limited to use with such interconnect applications or systems. The concepts can be extended to a range of different interconnect systems and applications.

The cable adapter 100 includes a housing 110 and other components described below. The cable adapter 100 is interposed between the four (4) cables 10A-10D on one side and the four (4) cables 12A-12D on another side of the cable adapter 100. The cables 10A-10D enter the housing 110 at a first side 111 of the housing 110, and the cables 12A-12D enter the housing 110 at a second side 112 of the housing 110. The first side 111 of the housing 110 extends in a separate plane from the second side 112 in the example shown.

The cables 10A-10D are smaller than the cables 12A-12D. While accommodating that difference in size, the cable adapter 100 electrically couples the cables 10A-10D to the cables 12A-12D. More particularly, the cable adapter 100 electrically couples the conductors of the cable 10A to the cable 12A. The cable adapter 100 also electrically couples the conductors of the cable 10B to the cable 12B, electrically couples the conductors of the cable 10C to the cable 12C, and electrically couples the conductors of the cable 10D to the cable 12D.

The cable adapter 100 includes internal components to secure the cables 10A-10D and 12A-12D in place within the housing 110, provide electrical interconnections between the conductors in the cables 10A-10D and 12A-12D, shield the conductors, and facilitate the transmission of data signals between the conductors of the cables 10A-10D and 12A-12D. The cable adapters described herein are not limited to use with any number of cables, other than to provide a transitional adapter between at least two cables of different sizes. The transitional cable adapter concepts can be extended to use with two (2), three (3), four (4), five (5), six (6), seven (7), eight (8), or more pairs of cables, where one cable in each pair is larger than another cable in each pair.

The cables 10A-10D are smaller than the cables 12A-12D overall. In the example shown, each of the cables 12A-12D includes two (2) conductors of a first gauge, such as 26, 28, or 29 AWG, and each of the cables 10A-10D includes two (2) conductors of a second gauge, such as 32 or 34 AWG. Thus, the diameters of the conductors in the cables 10A-10D are smaller than the conductors in the cables 12A-12D. Because the 32 or 34 AWG conductors in the cables 10A-10D have a smaller diameter than the 26, 28, or 29 AWG conductors in the cables 12A-12D, the conductors of the cables 10A-10D may not spatially align with the conductors of the cables 12A-12D. The conductors in the cables 10A-10D can also be offset in pitch and position as compared to the conductors in the cables 12A-12D. The cable adapter 100 includes components that facilitate the transition between the different sizes, pitches, and positions of the conductors in the cables 10A-10D and 12A-12D.

Overall, the cable adapter 100 provides an electrical coupling and transition between the conductors of the cables 10A-10D and 12A-12D, although the conductors of the cables 10A-10D and 12A-12D have different diameters and pitches. The cable adapter 100 is designed for improved impedance or permittivity in the transition between the conductors of the cables 10A-10D and 12A-12D as compared to other techniques for coupling the conductors. The cable adapter 100 also helps to reduce the undesirable effects that can be imparted upon data signals communicated over the cables 10A-10D and 12A-12D when the conductors in the cables 10A-10D and 12A-12D are electrically coupled together. As examples, the improved transition provided by the cable adapter 100 can reduce signal reflections, reduce interference and crosstalk, reduce distortion, increase signal to noise ratios, and increase bandwidth in transitions between conductors of different diameters, such as conductors of different diameters in twinax cables.

FIG. 2B illustrates an exploded perspective view of the cable adapter 100 and the cables 10A-10D and 12A-12D shown in FIG. 2A, and FIG. 2C illustrates a perspective view of the cable adapter 100 with certain components omitted. Referring between FIGS. 2B and 2C, the cable adapter 100 includes the housing 110, having an upper housing 110A and a lower housing 110B, and the shielded components 102. The shielded components 102 include an upper shield plate 130A, a lower shield plate 130B, and transitional adapter ferrules 200A-200D (see FIG. 2C). The upper housing 110A, lower housing 110B, upper shield plate 130A, lower shield plate 130B, and adapter ferrules 200A-200D are illustrated as representative examples and are not drawn to any particular scale or size in FIGS. 2B and 2C. The shapes, sizes, styles, proportions, and other characteristics of the components can vary in practice and among the embodiments as compared to that shown. For example, the cables 10A-10D and 12A-12D are illustrated in FIGS. 2A-2C at cut lengths that are shorter than would be relied upon in practice. Each of the cables 10A-10D and 12A-12D extends at one distal end to the adapter ferrules 200A-200D within the cable adapter 100 and, at another end, to other components in a larger device or system.

The housing 110 can be formed by injection molding in some cases. The housing 110 can be molded around the shielded components 102, after the shielded components 102 have been arranged or assembled together. Thus, the housing 110 can be embodied as a single integrated part surrounding the shield plates 130A and 130B, the adapter ferrules 200A-200D, and the ends of the cables 10A-10D and 12A-12D. In other examples, the housing 110 can be embodied as two or more separate components, such as the upper housing 110A and the lower housing 110B shown in FIG. 2B. In that case, the upper housing 110A and the lower housing 110B can be secured or held together around the shielded components 102 by welding (e.g., heating, melting, reflowing, etc.), adhesives, straps, screws, bolts, clips, or other mechanical fasteners, or using other suitable means. The housing 110 can be formed from a plastic or polymer, such as liquid crystal polymer (LCP), polyethylene (PE), polytetrafluoroethylene (PTFE), fluoropolymer, or other plastic or insulating material(s). The housing 110 can be formed using any suitable additive or subtractive manufacturing techniques, including molding, injection molding, printing, and other techniques.

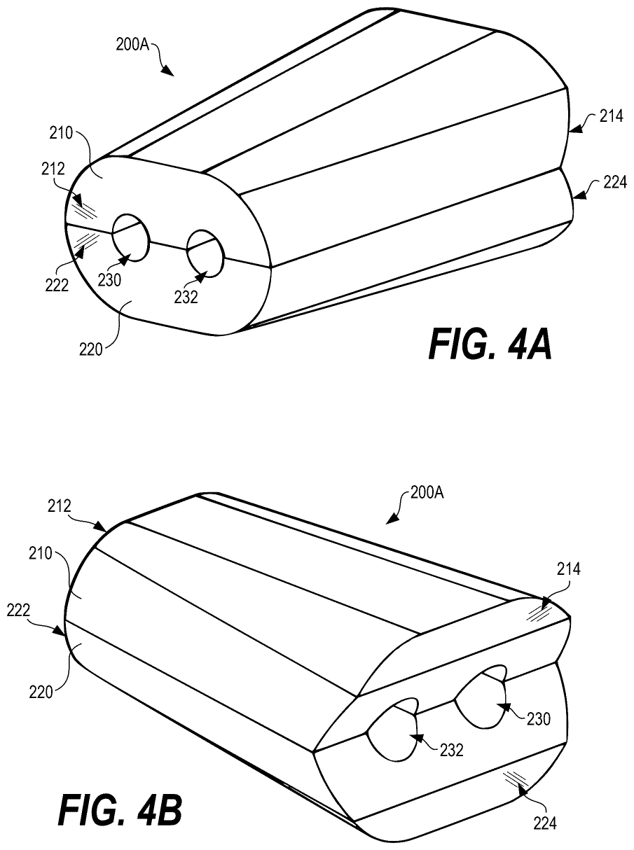

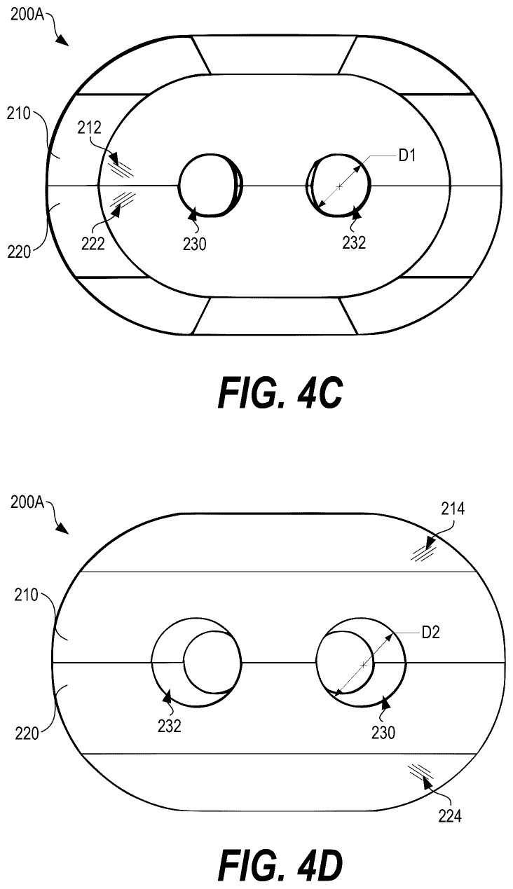

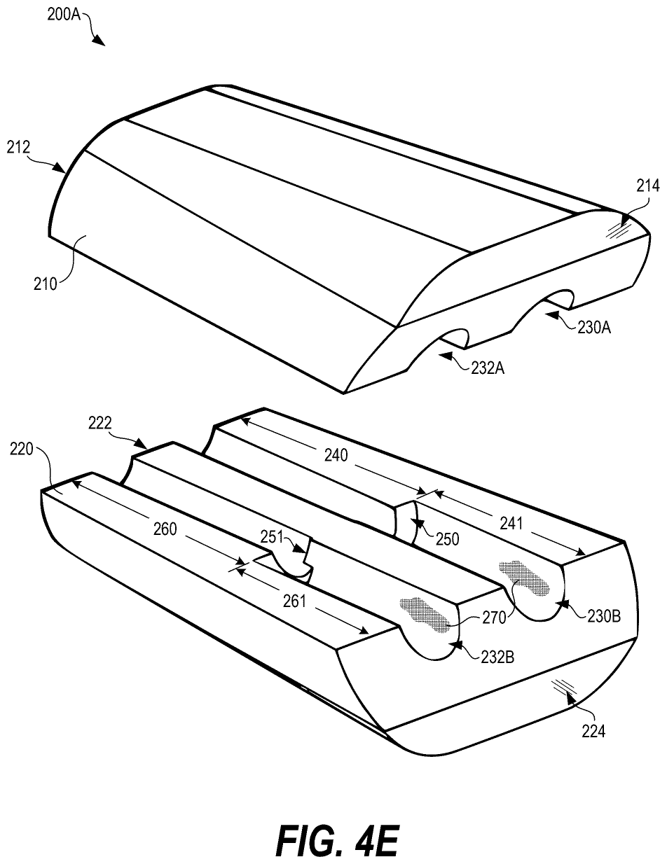

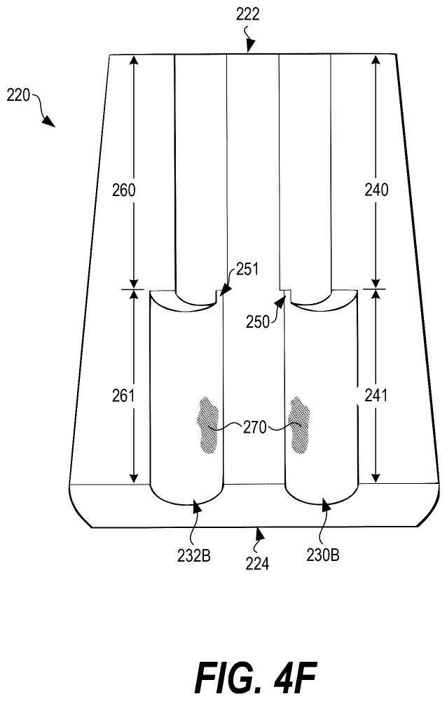

The adapter ferrules 200A-200D are positioned between the ends of the cables 10A-10D and 12A-12D. The adapter ferrules 200A-200D electrically couple the conductors in the cables 10A-10D with the conductors in the cables 12A-12D. More particularly, the adapter ferrule 200A is positioned between and electrically couples the conductors of the cable 10A to the conductors of the cable 12A. The adapter ferrule 200B electrically couples the conductors of the cable 10B to the conductors of the cable 12B. The adapter ferrule 200C electrically couples the conductors of the cable 10C to the conductors of the cable 12C, and the adapter ferrule 200D electrically couples the conductors of the cable 10D to the conductors of the cable 12D. Additional features and aspects of the adapter ferrules 200A-200D are described below with reference to FIGS. 4A-4F.

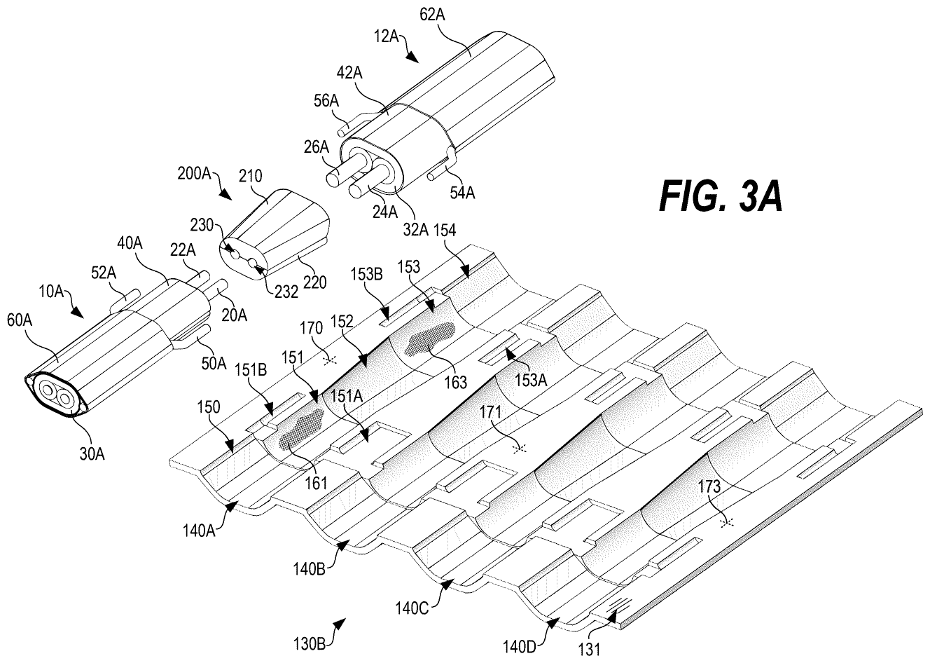

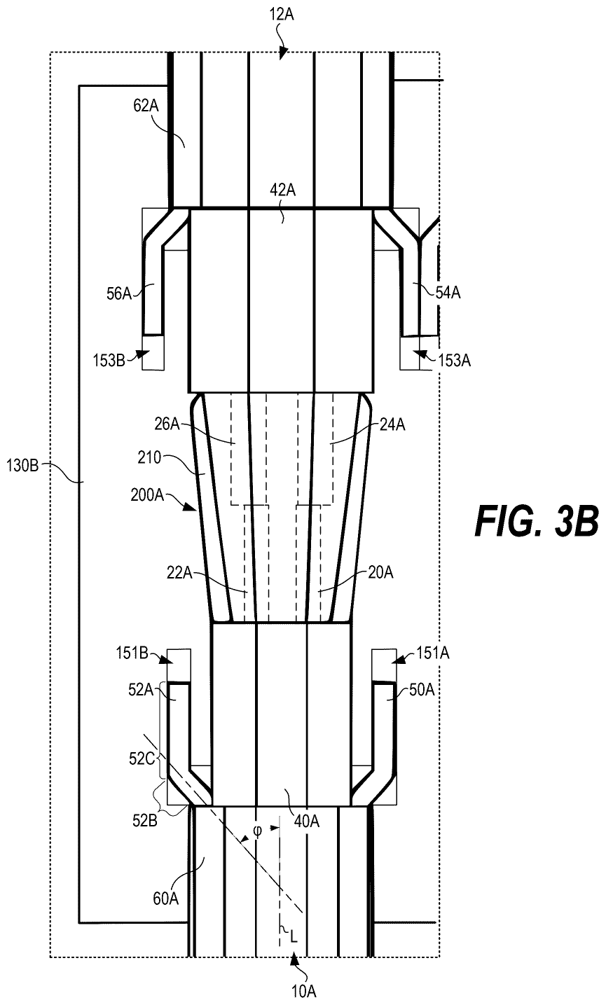

Each of the upper shield plate 130A and the lower shield plate 130B can be embodied as a conductive sheet of material that is sheared, bent, pressed, stamped, or otherwise formed into shape and size. The shield plates 130A and 130B are designed to provide a shield against electromagnetic interference (EMI) and related electrical effects within the cable adapter 100, and the shield plates 130A and 130B operate as an extension of the shield layers of the cables 10A-10D and 12A-12D. The shield plates 130A and 130B can be formed from a sheet of aluminum, copper, copper alloy (e.g., bronze, phosphor bronze, beryllium copper, leaded nickel copper, etc.), or other conductive metal or metal allow and plated with nickel, tin, rhodium, silver, gold, or other plating metal(s) in some cases. The thickness of the shield plates 130A and 130B can vary among the embodiments, and any suitable thickness can be relied upon. The shield plates 130A and 130B are stamped and formed to include pockets or depressions. The depressions are formed in a shape to coincide with the outer profile and outer surfaces of the cables 10A-10D and 12A-12D and the adapter ferrules 200A-200D. Additional features and aspects of the shield plates 130A and 130B are described below with reference to FIG. 3A.

The upper housing 110A and the upper shield plate 130A are omitted from view in FIG. 2C. The cables 10A-10D and 12A-12D and the adapter ferrules 200A-200D are shown seated in depressions of the lower shield plate 130B, and the lower housing 110B is shown molded around the lower shield plate 130B and the cables 10A-10D and 12A-12D. The cable 10A, as shown in FIG. 2C, is similar to the cable 10 shown in FIGS. 1A and 1B. The cable 10A includes first and second inner conductors (not shown in FIG. 2C), a dielectric insulator 30A, a shield 40A, a first drain conductor 50A, a second drain conductor 52A, and a jacket 60A. The inner conductors of the cable 10A can be 32 or 34 AWG, for example. Each of the cables 10B-10D is similar to the cable 10A. The cable 12A includes inner conductors of larger diameter, such as 26, 28, or 29 AWG, as compared to the cable 10A. The cable 12A includes first and second inner conductors (not shown in FIG. 2C), a dielectric insulator (not shown in FIG. 2C), a shield 42A, a first drain conductor 54A, a second drain conductor 56A, and a jacket 62A. Each of the cables 12B-12D is similar to the cable 12A.

Within the cable adapter 100, the jacket 60A of the cable 10A is stripped back and the shield 40A and the drain conductors 50A and 52A extend beyond the jacket 60A. The drain conductors 50A and 52A are turned or bent out and away from the central longitudinal axis of the cable 10A. The drain conductors 50A and 52A are also cut shorter than the remaining components of the cable 10A in the example shown. The drain conductors 50A and 52A are seated into drain pockets of the lower shield plate 130B. Although not shown in FIG. 2C, the drain conductors 50A and 52A are also seated into drain pockets of the upper shield plate 130A. The drain conductors 50A and 52A make physical and electrical contact with outer conductive surfaces of the shield plates 130A and 130B for shielding. The outer conductive surface of the shield 40A also makes physical and electrical contact with outer conductive surfaces of the shield plates 130A and 130B.

Strain relief in the cable adapter 100 is improved or enhanced based on bends in the drain conductors 50A and 52A and interferences between the drain conductors 50A and 52A and drain pockets of the shield plates 130A and 130B, as described in further detail below. More particularly, the interferences between the drain conductors 50A and 52A and the shield plates 130A and 130B help to prevent the cable 10A from being pulled out from within the housing 110 of the cable adapter 100. As compared to the cable 10A, each of the cables 10B-10D is prepared and secured within the cable adapter 100 in a similar way.

Turning to the cable 12A, the jacket 62A is stripped back, and the shield 42A and the drain conductors 54A and 56A extend beyond the jacket 62A. The drain conductors 54A and 56A are turned or bent out and away from the central longitudinal axis of the cable 12A. The drain conductors 54A and 56A are also cut shorter than the remaining components of the cable 12A in the example shown. The drain conductors 54A and 56A are seated into drain pockets of the lower shield plate 130B. Although not shown in FIG. 2C, the drain conductors 54A and 56A are also seated into drain pockets of the upper shield plate 130A. The drain conductors 54A and 56A make physical and electrical contact with outer conductive surfaces of the shield plates 130A and 130B for shielding. The outer conductive surface of the shield 42A also makes physical and electrical contact with outer conductive surfaces of the shield plates 130A and 130B. Additionally, based on the bends in the drain conductors 54A and 56A and the mechanical interferences between the drain conductors 54A and 56A and the drain pockets of the shield plates 130A and 130B, the drain conductors 54A and 56A provide strain relief in the cable adapter 100. As compared to the cable 12A, each of the cables 12B-12D is prepared and secured within the cable adapter 100 in a similar way.

FIG. 3A illustrates a perspective view of the lower shield plate 130B in the cable adapter 100 shown in FIG. 2A. FIG. 3A also illustrates the cable 10A, the adapter ferrule 200A, and the cable 12A. In the cable adapter 100, the upper shield plate 130A can be the same (i.e., same materials, size, shape, profile, etc.) as the lower shield plate 130A, although the upper and lower shield plates can be different in some cases if needed. The lower shield plate 130B is a conductive sheet of material that is sheared, bent, pressed, stamped, or otherwise formed into the shape shown in FIG. 3A. The lower shield plate 130B is particularly formed for use with the cables 10A-10D and 12A-12D in the example shown. In other words, the shapes of the transition channels in the lower shield plate 130B are stamped, pressed, or otherwise formed to coincide with the outer profile and surfaces of the cables 10A-10D and 12A-12D and the adapter ferrules 200A-200D. Other shield plates can be formed for use with cables having different profiles as needed.

The shield plate 130B includes transition channels 140A-140D. The transition channels 140A-140D are regions of the shield plate 130B that are depressed down from the planar surface 131 of the shield plate 130B. The transition channels 140A-140D are formed to coincide with the outer profile and surfaces of the cables 10A-10D and 12A-12D and the adapter ferrules 200A-200D. As an example, the surfaces in the transition channel 140A are formed to coincide with the outer surfaces of the cable 10A, the adapter ferrule 200A, and the cable 12A. Thus, when assembled together as described below, the cables 10A and 12A and adapter ferrule 200A fit within the transition channel 140A of the lower shield plate 130B with conforming contact of the surfaces between them. The upper shield plate 130A also fits over the cables 10A and 12A and adapter ferrule 200A with conforming contact of the surfaces between them.

In FIG. 3A, the cables 10A and 12A are prepared for assembly of the cable adapter 100. The cables 10B-10D and 12B-12D are also prepared in a similar way, although not illustrated in FIG. 3A. As shown, the jacket 60A of the cable 10A is stripped back, and the shield 40A and the drain conductors 50A and 52A extend beyond the jacket 60A. The shield 40A and the dielectric insulator 30A are also stripped back, and the first and second conductors 20A and 22A extend beyond the shield 40A and dielectric insulator 30A. The drain conductors 50A and 52A are turned or bent out and away from the central longitudinal axis of the cable 10A.

The jacket 62A of the cable 12A is also stripped back, and the shield 42A and the drain conductors 54A and 56A extend beyond the jacket 62A. The shield 42A and the dielectric insulator 32A are also stripped back, and the first and second conductors 24A and 26A extend beyond the shield 42A and dielectric insulator 32A. The drain conductors 54A and 56A are turned or bent out and away from the central longitudinal axis of the cable 12A.

The adapter ferrule 200A includes a pair of openings or apertures 230 and 232, and the conductors 20A, 22A, 24A and 26A extend within those apertures 230 and 232. The inner surfaces of the apertures 230 and 232 can include a conductive lining in some cases. The conductive lining within the aperture 230 provides an electrical coupling between the conductors 22A and 26A, and the conductive lining within the aperture 232 provides an electrical coupling between the conductors 20A and 24A. The conductive linings within the apertures 230 and 232 are described below with reference to FIGS. 4E and 4F.

After the cables 10A and 12A are prepared as shown in FIG. 3A, the cables 10A and 12A and the adapter ferrule 200A can be placed and seated into the transition channel 140A of the lower shield plate 130B. In the example shown, the adapter ferrule 200A includes two components or pieces. The adapter ferrule 200A includes an upper ferrule section 210 and a lower ferrule section 220. The ferrule sections 210 and 220 are separable from each other. These and other aspects of the adapter ferrule 200A and the adapter ferrules 200B-200D are described below with reference to FIGS. 4A-4F.

The transition channel 140A includes seats 150-154 along the length of the transition channel 140A. The transition channel 140A includes a jacket seat 150 for the outer jacket 60A of the cable 10A, a shield seat 151 for the shield 40A of the cable 10A, an adapter seat 152 for the adapter ferrule 200A, a shield seat 153 for the shield 42A of the cable 12A, and a jacket seat 154 for the outer jacket 62A of the cable 12A. The transition channel 140A also includes drain pockets 151A, 151B, 153A, and 153B. The drain pockets 151A, 151B are extensions of the shield seat 151, and the drain pockets 153A, 153B are extensions of the shield seat 153.

The cables 10A and 12A and the adapter ferrule 200A can be placed into the transition channel 140A of the lower shield plate 130B in a number of different ways depending on how the cable adapter 100 is designed and assembled. In the example shown in FIG. 3A, the lower ferrule section 220 can be seated into the adapter seat 152 first (i.e., before the cables 10A and 12A are seated). Then, the cable 10A can be seated into the seats 150 and 151 of the transition channel 140A. The outer jacket 60A of the cable 10A will contact the surfaces of the jacket seat 150, and the shield 40A of the cable 10A will contact the surfaces of the shield seat 151 when the cable 10A is positioned. The shield 40A of the cable 10A will electrically contact and couple to the lower shield plate 130B in the seat 151. Additionally, the drain conductors 50A and 52A of the cable 10A will seat into and electrically couple with the drain pockets 151A and 151B, respectively. Further, although not shown in FIG. 3A, the conductors 20A and 22A of the cable 10A are positioned within channels extending within the lower ferrule section 220 as described below.

The cable 12A can also be placed into the transition channel 140A. The outer jacket 62A of the cable 12A will contact the surfaces of the jacket seat 154, and the shield 42A of the cable 12A will contact the surfaces of the shield seat 153 when the cable 12A is positioned. The shield 42A of the cable 12A will electrically contact and couple to the lower shield plate 130B in the seat 153. Additionally, the drain conductors 54A and 56A of the cable 12A will seat into and electrically couple with the drain pockets 153A and 153B, respectively. Further, although not shown in FIG. 3A, the conductors 24A and 26A of the cable 12A are positioned within channels extending within the lower ferrule section 220 as described below.

Once the lower ferrule section 220 and the cables 10A and 12A are positioned and seated within the transition channel 140A of the lower shield plate 130B, the upper ferrule section 210 can be placed over the lower ferrule section 220. The cables 10B-10D and 12B-12D and adapter ferrules 200B-200D can be positioned and assembled within the transition channels 140B-140D of the lower shield plate 130B in a similar way, and an example of this arrangement is shown in FIG. 2C. The cables 10B and 12B and the adapter ferrule 200B are positioned within the transition channel 140B. The cables 10C and 12C and the adapter ferrule 200C are positioned within the transition channel 140C, and the cables 10D and 12D and the adapter ferrule 200D are positioned within the transition channel 140D. Then, the upper shield plate 130A can be positioned and placed over the lower shield plate 130B (e.g., see FIG. 2B).

Once the cables 10A-10D, adapter ferrules 200B-200D, and shield plates 130A and 130B are assembled, the housing 110 can be molded around them. In one example, the cables 10A-10D, adapter ferrules 200B-200D, and shield plates 130A and 130B can be assembled within a mold for the housing 110, and the housing 110 can be injected into the mold after the shielded components 102 (see FIG. 2B) are assembled together. Thus, the housing 110 helps to secure the shielded components 102 in place. The housing 110 can be molded as a single component using a plastic or polymer, such as LCP, PE, PTFE, fluoropolymer, or other plastic or insulating material(s). The housing 110 can also be formed and secured around the shielded components 102 in other ways. In other examples, the housing 110 can be embodied as two or more separate components, such as the upper housing 110A and the lower housing 110B shown in FIG. 2B. In that case, the upper housing 110A and the lower housing 110B can be secured or held together around the shielded components 102 by welding (e.g., heating, melting, reflowing, etc.), adhesives, straps, screws, bolts, clips, or other mechanical fasteners, or using other suitable means.

The cable adapter 100 can be assembled in other ways, however. For example, the cables 10A and 12A can be prepared as shown in FIG. 3A. The tips or ends of the conductors 20A and 24A can be soldered or welded together. The tips or ends of the conductors 22A and 26A can also be soldered or welded together. Then, the adapter ferrule 200A can be molded as a single part or piece around the exposed conductors 20A, 22A, 24A and 26A of the cables 10A and 12A. In this case, the apertures 230 and 232 may omit the conductive lining described below with reference to FIGS. 4E and 4F. The other cables 10B-10D and 12B-12D and adapter ferrules 200B-200D can be prepared in a similar way before being positioned with the shield plates 130A and 130B.

Referring again to FIG. 3A, the lower shield plate 130B can include scored, serrated, or roughened surface areas in some cases. Roughened surface areas 161 and 163 are identified in FIG. 3A as examples. The roughened surface areas 161 and 163 can extend over one or more regions of the shield seats 151 and 153. In other cases, the roughened surface areas 161 and 163 can extend throughout the shield seats 151 and 153. The roughened surface areas 161 and 163 of the lower shield plate 130B, among others, can be formed through laser etching, chemical etching, scoring, sanding, or other techniques. The roughened surface areas 161 and 163 can help to establish electrical couplings between the lower shield plate 130B and the shields 40A and 42A of the cables 10A and 12A. In some cases, the surfaces of the drain pockets 151A, 151B, 153A, and 153B can also include roughened surface areas. The shield seats and drain pockets in the other transition channels 140B-140D can also include roughened surface areas, and the upper shield plate 130A can also include roughened surface areas.

Adhesives, conductive adhesives, conductive pastes, solders, and other substances can be applied to surfaces of the shield plates 130A and 130B in some cases, to help establish mechanical, electrical, or mechanical and electrical couplings between the cables 10A-10D and 12A-12D and the shield plates 130A and 130B. Conductive adhesive, for example, can be applied to the shield seats 151 and 153 to support or enhance the electrical coupling between the shields 40A and 42A of the cables 10A and 12A and the shield plate 130B. Conductive adhesive can also be applied to the drain pockets 151A, 151B, 153A, and 153B of the shield plate 130B. Epoxy or other adhesives can be applied to the jacket seats 150 and 154 for mechanical coupling with the outer jackets 60A and 62A of the cables 10A and 12A.

In some cases, the upper shield plate 130A can be welded to the lower shield plate 130B after the shielded components 102 (see FIG. 2B) are assembled together. FIG. 3A illustrates weld locations 170-173, as example locations where the shield plates 130A and 130B can be welded together. The weld locations 170-173 are provided as representative examples, however, and other weld locations can be positioned between the transition channels 140A-140D, at the corners of the shield plates 130A and 130B, around the periphery of the shield plates 130A and 130B, and at combinations of those locations.

FIG. 3B illustrates a plan view of the region designated “3B” in FIG. 2C. FIG. 3B illustrates how the drain conductors 50A and 52A of the cable 10A are seated in the drain pockets 151A and 151B, respectively. The drain conductors 54A and 56A of the cable 12A are also seated in the drain pockets 153A and 153B, respectively. FIG. 3B also illustrates the conductors 20A and 22A of the cable 10A and the conductors 24A and 26A of the cable 12A extending within the adapter ferrule 200A using hidden lines.

The drain conductors 50A and 52A of the cable 10A are turned or bent out and away from the central longitudinal axis “L” of the cable 10A. For example, as shown in FIG. 3B, an angled length 52B of the drain conductor 52A extends at an angle φ from the longitudinal axis “L” of the cable 10A. The angle φ is about 45 degrees (°) in the example shown. The angle φ can range among the embodiments, such as any increment of 1° between 25-65°. Thus, examples of the angle φ include 25°, 30°, 35°, 40°, 45°, 50°, 55°, 60°, and 65°. The drain conductors 54A and 56A of the cable 12A are also turned or bent out and away from the central longitudinal axis of the cable 12A in a similar way.

The drain conductor 52A also includes the parallel length 52C at the end of the angled length 52B. The parallel length 52C extends parallel to the longitudinal axis “L” of the cable 10A. The drain conductor 52A is cut shorter than the conductors 20A and 22A of the cable 10A in the example shown. However, the parallel length 52C can extend further than that shown in FIG. 3B. The parallel length 52C of the drain conductor 52A can extend to or beyond the end of the shield 40A in some cases. The drain conductor 50A can also extend to or beyond the end of the shield 40A in some cases, and the drain pockets 151A and 151B can be adjusted accordingly. The drain conductors 54A and 56A of the cable 12A can also extend to or beyond the end of the shield 42A.

The bends and the mechanical interferences between the drain conductors 50A and 52A of the cable 10A and the drain pockets 151A and 151B provide strain relief in the cable adapter 100. The mechanical interferences between the drain conductors 54A and 56A of the cable 12A and the drain pockets 153A and 153B also provide strain relief in the cable adapter 100. The interferences help to prevent the cables 10A and 12A from being pulled out from within the shield plates 130A and 130B and the housing 110 of the cable adapter 100. In other cases, the drain conductors 50A, 52A, 54A and 56A can extend straight without any bend, and the drain pockets 151A, 151B, 153A, and 153B can be adjusted accordingly.

FIG. 4A illustrates a front perspective view, FIG. 4B illustrates a back perspective view, FIG. 4C illustrates a front view, and FIG. 4D illustrates a back view of the adapter ferrule 200A in the cable adapter 100. The adapter ferrule 200A is illustrated as a representative example and is not drawn to any particular scale or size. The shape, size, proportion, and other characteristics of the adapter ferrule 200A can vary as compared to that shown. In the cable adapter 100, the adapter ferrules 200B-200D can be the same as the adapter ferrule 200A.

The adapter ferrule 200A includes the upper ferrule section 210 and the lower ferrule section 220. The ferrule sections 210 and 220 are separable from each other in the example shown. However, in other cases, the adapter ferrule 200A can be formed as a single integrated part or piece. The adapter ferrule 200A can be formed from a dielectric insulating material, such as a polyolefin, PE, PTFE, fluoropolymer, or other plastic or insulating material. An example dielectric constant Dk of the insulating material can range from 1.5-3, although the adapter ferrule 200A is not limited to any particular type of insulating material. In some cases, the insulating material of the adapter ferrule 200A includes a laser direct structuring (LDS) additive. A laser beam can be used to activate the LDS additive over certain surfaces or surface areas of the adapter ferrule 200A for selective-area metallization, as described below. The adapter ferrule 200A shown in FIGS. 4A-4E is representative of the other adapter ferrules 200B-200D described herein, and each of the other adapter ferrules 200B-200D can be the same as the adapter ferrule 200A. In other cases, the cable adapter 100 can include two, three, or more different types or styles of adapter ferrules depending on the cables being transitioned.

Referring among FIGS. 4A-4D, the ferrule sections 210 and 220 include front surfaces 212 and 222 and back surfaces 214 and 224, respectively. The ferrule sections 210 and 220 taper from the relatively smaller front surfaces 212 and 222 to the relatively larger back surfaces 214 and 224. The adapter ferrule 200A includes the apertures 230 and 232, which extend from the front surfaces 212 and 222 to the back surfaces 214 and 224. The apertures 230 and 232 are formed by semicircular channels in the ferrule sections 210 and 220, which are described below with reference to FIGS. 4E and 4F. The apertures 230 and 232 are circular to accommodate the conductors 20A and 22A of the cable 10A and the conductors 24A and 26A of the cable 12A. The apertures 230 and 232 can include a conductive lining on at least a region or length of the inner surface of the apertures 230 and 232 within the adapter ferrule 200A, as also described below.

The apertures 230 and 232 include a transition from a first diameter “D1” (see FIG. 4C) or size at the front surfaces 212 and 222 to a second diameter “D2” (see FIG. 4C) or size at the back surfaces 214 and 224. In the example shown, the sizes of the openings in the front surfaces are smaller in diameter than the sizes of the openings at the back surfaces (i.e., “D1”<“D2”). D1 can be selected based on the diameter or AWG of the conductors 20A and 22A of the cable 10A. D2 can be selected based on the diameter or AWG of the conductors 24A and 26A of the cable 12A. The transitions between the diameters D1 and D2 are described below with reference to FIGS. 4E and 4F.

FIG. 4E illustrates an exploded view of the adapter ferrule 200A, and FIG. 4F illustrates a plan view of the lower ferrule section 220 of the adapter ferrule 200A. As shown in FIGS. 4F and 4E, the apertures 230 and 232 (see FIG. 4A) are formed by semicircular channels in the ferrule sections 210 and 220. The ferrule section 210 includes semicircular channels 230A and 232A, and the ferrule section 220 includes semicircular channels 230B and 232B. When the ferrule sections 210 and 220 are assembled together as shown in FIGS. 4A-4D, the semicircular channels 230A and 230B make the aperture 230. The semicircular channels 232A and 232B make the aperture 232. However, in other cases, the adapter ferrule 200A can be formed as a single integrated part or piece, in which case the apertures 230 and 232 can be formed directly through the adapter ferrule 200A.

The semicircular channels 230A and 232A extend from the front to the back of the ferrule section 210, and the semicircular channels 230B and 232B extend from the front to the back of the ferrule section 220. As shown in FIGS. 4E and 4F, the channel 230B includes a first channel length 240 and a second channel length 241, with a transition 250 at an interface between them within the ferrule section 220. The channel 232B also includes a first channel length 260 and a second channel length 261, with a transition 251 at an interface between them within the ferrule section 220. The first channel length 240 is sized for the first diameter “D1” (see FIG. 4C), and the second channel length 241 is sized for the second diameter “D2” (see FIG. 4D). The first channel length 260 is also sized to the same first diameter “D1”, and the second channel length 261 is also sized to the same second diameter “D2”. The first diameter is smaller than the second diameter. Each of the semicircular channels 230A and 232A of the ferrule section 210 also include first and second channel lengths with transitions between them, which correspond in shape, size, and position to those in the ferrule section 220.

The internal diameters of the apertures 230 and 232 within the adapter ferrule 200A, as formed by the channel lengths within the ferrule sections 210 and 220, can be selected based on the types of cables used with the cable adapter 100 and to accommodate the gauges of the conductors in the cables. As one example, the diameter “D1” of the apertures 230 and 232 shown in FIG. 4C can be sized to accommodate the conductors 20A and 22A of the cable 10A with an interference fit (e.g., contact with no gap) between the outer surfaces of the conductors 20A and 22A and the inner surfaces of the apertures 230 and 232. The pitch or spacing between the centers of the openings of the apertures 230 and 232 at the front surfaces 212 and 222 of the adapter ferrule 200A can also be aligned with the pitch of spacing of the conductors 20A and 22A of the cable 10A. Further, the diameter “D2” of the apertures 230 and 232 shown in FIG. 4D can be sized to accommodate the conductors 24A and 26A of the cable 12A with an interference fit between the outer surfaces of the conductors 24A and 26A and the inner surfaces of the apertures 230 and 232. The pitch or spacing between the centers of the openings of the apertures 230 and 232 at the back surfaces 214 and 224 of the adapter ferrule 200A can also be aligned with the pitch of spacing of the conductors 24A and 26A of the cable 12A.

The inner surfaces of the apertures 230 and 232 can include a lining 270 of conductive material in some cases. The lining 270 can extend along at least a length of the apertures 230 and 232 within the adapter ferrule 200A from the front surfaces 212 and 222 to the back surfaces 214 and 224 of the ferrule sections 210 and 220. Thus, the apertures 230 and 232 are conductive apertures due to the lining 270 of conductive material. The lining 270 can extend along the entire channel lengths 240, 241, 260, and 261, or portions thereof, and across the transitions 250 and 251 in the ferrule section 220. The lining can also extend along the channel lengths and transitions in the ferrule section 210.

The lining 270 of conductive material can include one or more metal layers, metal alloy layers, metal particle layers, or other layers of conductive material. The lining 270 of conductive material can be deposited or formed on the inner surfaces of the apertures 230 and 232 in a number of different ways. As one example, the insulating material of the adapter ferrule 200A can include an LDS additive. A laser beam can be used to activate the LDS additive over surfaces or surface areas of the apertures 230 and 232 or the channels of the ferrule sections 210 and 220. A subsequent metallization step can be performed by submerging the ferrule sections 210 and 220 of the adapter ferrule 200A in a bath, and conductive metal plating can adhere to the activated surfaces or surface areas. A number of different layers of metal, such as copper, nickel, tin, gold, or other plating metals or combinations thereof can be successively plated using this approach.

In other examples, the lining 270 of conductive material can be deposited or otherwise formed by chemical or physical vapor deposition, sputtering, evaporation, plating, spin coating, dip coating, epitaxial growth, or other techniques. The metal, metal alloy, or metal particle layers can include copper, silver, gold, titanium, platinum, tungsten, or other metals and alloys thereof. In some cases, the lining 270 of conductive material can include raised ridges, bumps, or other patterns of the conductive material along the apertures 230 and 232, where the thickness of the conductive material lining varies in thickness. In some cases, the outer surfaces of the ferrule sections 210 and 220 of the adapter ferrule 200A can also include a lining of conductive material similar to the lining 270.

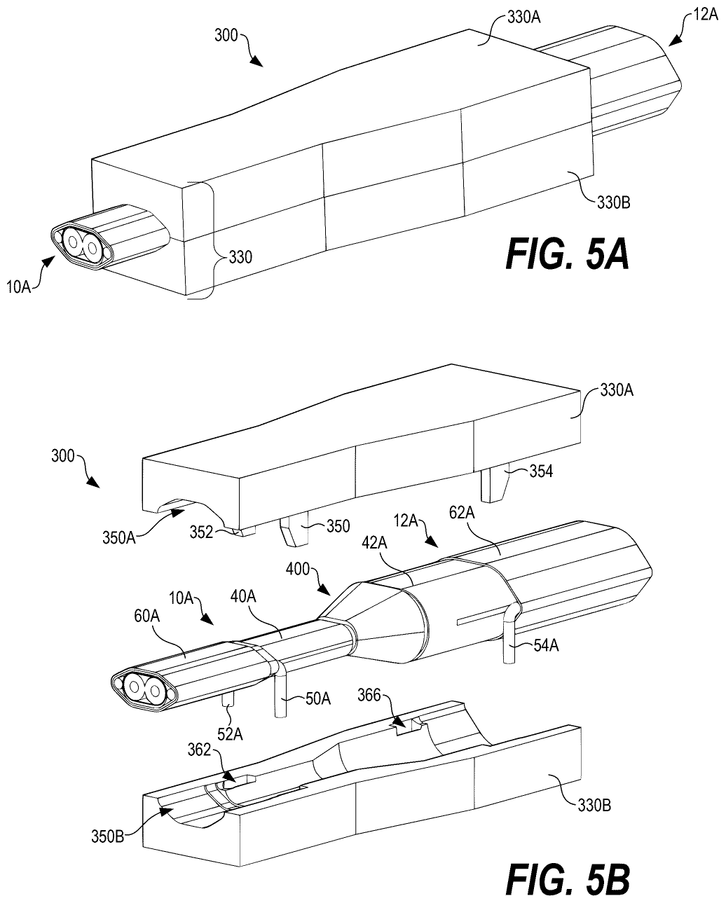

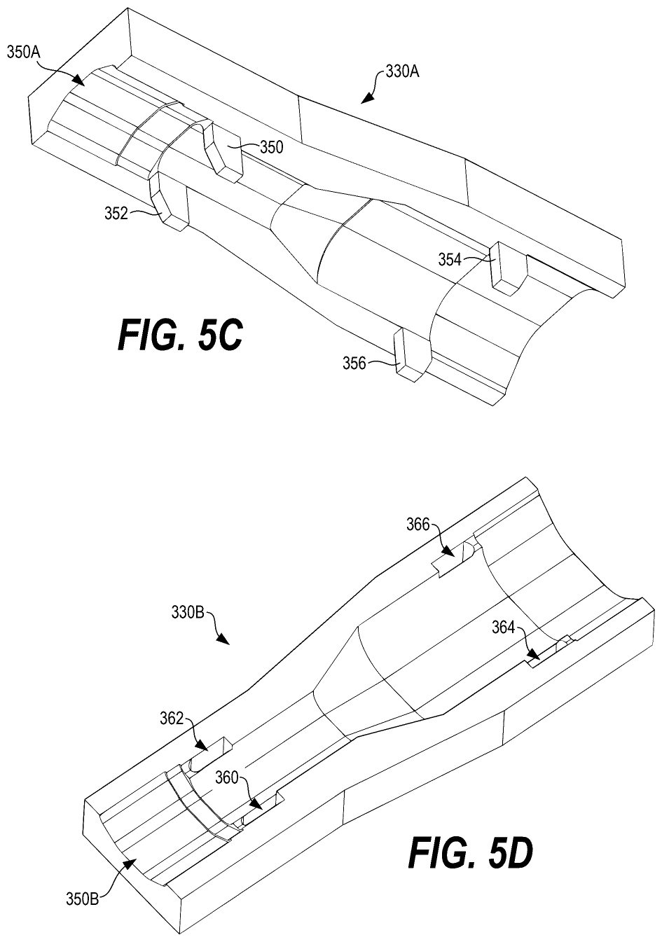

FIG. 5A illustrates a perspective view of another example transitional cable adapter 300 (also “cable adapter 300”) between the cables 10A and 12A, and FIG. 5B illustrates an exploded perspective view of the cable adapter 300 and cables 10A and 12A. The cable adapter 300 is illustrated as a representative example and is not drawn to any particular scale or size. The shape, size, style, proportion, and other characteristics of the cable adapter 300 can vary as compared to that shown and among the embodiments. In some cases, one or more features or components of the cable adapter 300 can be omitted. In other cases, the cable adapter 300 can include other features or components. For example, the cable adapter 300 can include another housing molded around the shield body described below.

Referring between FIGS. 5A and 5B, the cable adapter 300 includes a shield body 330 and a transitional adapter ferrule 400 between the cables 10A and 12A. The shield body 330 includes an upper shield body 330A and a lower shield body 330B. The transitional adapter ferrule 400 can be the same as or similar to the adapter ferrule 200A. The upper shield body 330A and the lower shield body 330B can be formed as plastic or polymer components, such as LCP, PE, PTFE, fluoropolymer, or other plastic or insulating material(s).

The upper shield body 330A includes a transition channel 350A, and the lower shield body 330B includes a transition channel 350B. The surfaces in the transition channels 350A and 350B are formed to coincide with the outer surfaces of the cable 10A, the adapter ferrule 400, and the cable 12A. Thus, when assembled together as described below, the cables 10A and 12A and adapter ferrule 400 fit within the transition channels 350A and 350B with conforming contact of the surfaces between them.

The surfaces of the transition channels 350A and 350B can include a conductive lining on inner surfaces in one example. The conductive lining can be deposited or formed on the surfaces of the transition channels 350A and 350B in a number of different ways. As one example, the insulating material of the upper shield body 330A and the lower shield body 330B can include an LDS additive. A laser beam can be used to activate the LDS additive over surfaces or surface areas of the transition channels 350A and 350B. A subsequent metallization step can be performed by submerging the shield bodies 330A and 330B in a bath, and conductive metal plating can adhere to the activated surfaces or surface areas. A number of different layers of metal, such as copper, nickel, tin, gold, or other plating metals or combinations thereof can be successively plated using this approach. In other examples, the conductive lining can be deposited or otherwise formed by chemical or physical vapor deposition, sputtering, evaporation, plating, spin coating, dip coating, epitaxial growth, or other techniques. The metal, metal alloy, or metal particle layers can include copper, silver, gold, titanium, platinum, tungsten, or other metals and alloys thereof. In some cases, the conductive lining can include raised ridges, bumps, or other patterns of the conductive material, where the thickness of the conductive material lining varies in thickness.

FIG. 5C illustrates a perspective view of the upper shield body 330A, and FIG. 5D illustrates a perspective view of the lower shield body 330B of the transitional cable adapter 300 shown in FIG. 5A. The shield bodies 330A and 330B include features to mechanically secure the drain conductors 50A, 52A, 54A, and 56A of the cables 10A and 12A. For that purpose, the upper shield body 330A includes bend fingers 350, 352, 354, and 356. The lower shield body 330B includes bend apertures 360, 362, 364, and 366.

To assemble the cable adapter 300, the cables 10A and 12A can be prepared with the drain conductors 50A, 52A, 54A, and 56A extending straight and cut to the lengths shown. The cables 10A, 12A, and the transitional adapter ferrule 400 can be assembled and placed into the transition channel 350B of the lower shield body 330B with the drain conductors 50A, 52A, 54A, and 56A extending straight. The upper shield body 330A can then be placed over and pressed down into the lower shield body 330B. The bend fingers 350, 352, 354, and 356 will then press and bend the drain conductors 50A, 52A, 54A, and 56A, respectively, into the bend apertures 360, 362, 364, and 366. The interferences and contact between the drain conductors 50A, 52A, 54A, and 56A and the bend apertures 360, 362, 364, and 366 help to prevent the cables 10A and 12A from being pulled out from within the cable adapter 300.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account at least for some manufacturing tolerances between a theoretical design and a manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. A transitional cable adapter, comprising:
a housing;
a shield; and
an adapter ferrule, the adapter ferrule comprising a conductive aperture, the conductive aperture comprising a first aperture length for a first conductor, a second aperture length for a second conductor, and a transition between the first aperture length and the second aperture length.

2. The transitional cable adapter according to claim 1, wherein:
the adapter ferrule comprises a dielectric insulating material; and
the conductive aperture of the adapter ferrule comprises a lining of conductive material on an inner surface.

3. The transitional cable adapter according to claim 1, wherein:
the first aperture length comprises a first diameter for a first gauge of the first conductor; and
the second aperture length comprises a second diameter for a second gauge of the second conductor.

4. The transitional cable adapter according to claim 1, wherein:
the shield comprises a lower shield plate and an upper shield plate; and
the adapter ferrule is positioned in a transition channel between the lower shield plate and the upper shield plate.

5. The transitional cable adapter according to claim 4, wherein the lower shield plate is welded to the upper shield plate in at least one location.

6. The transitional cable adapter according to claim 1, wherein:
the shield comprises a transition channel; and
the transition channel comprises an adapter seat for the adapter ferrule, a shield seat for a shield of a cable, a jacket seat for an outer jacket of the cable, and drain pockets for drain conductors of the cable.

7. The transitional cable adapter according to claim 6, wherein the shield seat comprises a roughened surface area.

8. The transitional cable adapter according to claim 6, wherein the housing is molded around the shield and the adapter ferrule.

9. The transitional cable adapter according to claim 1, wherein the adapter ferrule comprises an upper ferrule section and a lower ferrule section.

10. The transitional cable adapter according to claim 9, wherein at least one of the upper ferrule section or the lower ferrule section comprises a first channel length for the first conductor, a second channel length for the second conductor, and a transition between the first channel length and the second channel length.

11. A transitional cable adapter, comprising:
a first cable comprising a first conductor of a first gauge;
a second cable comprising a second conductor of a second gauge different than the first gauge;
an adapter ferrule comprising an aperture, the aperture comprising a first diameter for the first conductor, a second diameter for the second conductor, and a transition between the first diameter and the second diameter; and
a shield around the adapter ferrule.

12. The transitional cable adapter according to claim 11, wherein:
the adapter ferrule comprises a dielectric insulating material; and
the aperture of the adapter ferrule comprises a lining of conductive material on an inner surface.

13. The transitional cable adapter according to claim 11, wherein:
the shield comprises a lower shield plate and an upper shield plate; and
the adapter ferrule is positioned in a transition channel between the lower shield plate and the upper shield plate.

14. The transitional cable adapter according to claim 13, wherein the lower shield plate is welded to the upper shield plate in at least one location.

15. The transitional cable adapter according to claim 11, wherein:
the shield comprises a transition channel; and
the transition channel comprises an adapter seat for the adapter ferrule, a first drain pocket for a first drain conductor of the first cable, and a second drain pocket for a second drain conductor of the second cable.

16. The transitional cable adapter according to claim 15, wherein:
the first drain conductor of the first cable includes a first angled length;
the second drain conductor of the first cable includes a second angled length;
the first angled length is positioned within the first drain pocket; and
the second angled length is positioned within the second drain pocket.

17. The transitional cable adapter according to claim 11, wherein the shield comprises a roughened surface area for contact with a shield of at least one of the first cable and the second cable.

18. The transitional cable adapter according to claim 11, further comprising a housing molded around the shield and the adapter ferrule.

19. The transitional cable adapter according to claim 11, wherein the adapter ferrule comprises an upper ferrule section and a lower ferrule section.

20. The transitional cable adapter according to claim 19, wherein at least one of the upper ferrule section or the lower ferrule section comprises a first channel length for the first conductor, a second channel length for the second conductor, and a transition between the first channel length and the second channel length.
